(19) United States
(12) Patent Application Publication
(10) Pub. No.: US 2023/0087612 A1
(43) Pub. Date: Mar. 23, 2023

(54) SYSTEM, CIRCUIT, DEVICE AND/OR PROCESSES FOR NEURAL NETWORK TRAINING

(71) Applicant: Arm Limited, Cambridge (GB)

(72) Inventor: Mbou Eyole, Soham (GB)

(21) Appl. No.: 17/481,871

(22) Filed: Sep. 22, 2021

(51) Int. Cl. G06N 3/063; G06N 20/00; G06N 3/08

(52) U.S. Cl. CPC G06N 3/063; G06N 20/00; G06N 3/082

(57) ABSTRACT

Example methods, devices and/or circuits to be implemented in a processing device to perform operations based, at least in part, on machine-learning. According to an embodiment, one or more parameters of a neural network node may be altered based, at least in part, on one or more error signals that are based, at least in part, on one or more errors generated by a local operational circuit.

### BACKGROUND

### 1. Field

The present disclosure relates generally to neural network processing devices.

### 2. Information

Neural Networks have become a fundamental building block in machine-learning and/or artificial intelligence systems. A neural network may be constructed according to multiple different design parameters such as, for example, network depth, layer width, weight bitwidth, approaches to pruning, just to provide a few example design parameters that may affect the behavior of a particular neural network processing architecture. In a machine-learning process, parameters of one or more neural networks may be optimized according to a loss function in “training” operations, which may be computationally and/or energy intensive.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is a schematic diagram of a topology of an aspect of a spiking neural network according to an embodiment;

FIG. 2 is a flow diagram of a process of an aspect of an operation to train a spiking neural network according to an embodiment;

FIG. 3 is a schematic diagram of a circuit applicable to an aspect of an operation to train a spiking neural network according to an embodiment;

FIG. 4 is a flow diagram illustrating a time divisional multiplexing of an operation to train neural network according to an embodiment;

FIG. 5 is a schematic diagram illustrating a spatial architecture of an operation to train neural network according to an embodiment; and

FIG. 6 is a schematic diagram of an operational circuit to generate error signals according to an embodiment.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like means that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. In general, of course, as has always been the case for the specification of a patent application, these and other issues have a potential to vary in a particular context of usage. In other words, throughout the disclosure, particular context of description and/or usage provides helpful guidance regarding reasonable inferences to be drawn; however, likewise, “in this context” in general without further qualification refers at least to the context of the present patent application.

According to an embodiment, a neural network may comprise a graph comprising nodes to model neurons in a brain. In this context, a “neural network” as referred to herein means an architecture of a processing device defined and/or represented by a graph including nodes to represent neurons that process input signals to generate output signals, and edges connecting the nodes to represent to represent input and/or output signal paths between and/or among the artificial neurons represented by the graph. In particular implementations, a neural network may comprise a biological neural network, made up of real biological neurons, or an artificial neural network, made up of artificial neurons, for solving artificial intelligence (AI) problems, for example. In an implementation, such an artificial neural network may be implemented by one or more computing devices such as computing devices such as computing devices including a central processing unit (CPU), graphics processing unit (GPU), digital signal processing (DSP) unit and/or neural network processing unit (NPU), just to provide a few examples. In a particular implementation, neural network weights associated with edges to represent input and/or output paths may reflect gains to be applied and/or whether an associated connection between connected nodes is to be excitatory (e.g., weight with a positive value) or inhibitory connections (e.g., weight with negative value). In an example implementation, a neuron may apply a neural network weight to input signals, and sum weighted input signals to generate a linear combination.

According to an embodiment, edges in a neural network connecting nodes may model synapses capable of transmitting signals (e.g., represented by real number values) between neurons. Responsive to receipt of such a signal, a node/neural may perform some computation to generate an output signal (e.g., to be provided to another node in the neural network connected by an edge). Such an output signal may be based, at least in part, on one or more weights and/or numerical coefficients associated with the node and/or edges providing the output signal. For example, such a weight may increase or decrease a strength of an output signal. In a particular implementation, such weights and/or numerical coefficients may be adjusted and/or updated as a machine learning process progresses. In an implementation, transmission of an output signal from a node in a neural network may be inhibited if a strength of the output signal does not exceed a threshold value.

In particular implementations, neural networks may enable improved results in a wide range of tasks, including image recognition, speech recognition, just to provide a couple of example applications. To enable performing such tasks, features of a neural network (e.g., nodes, edges, weights, layers of nodes and edges) may be structured and/or configured to form “filters” that may have a measurable/numerical state such as a value of an output signal. Such a filter may comprise nodes and/or edges arranged in “paths” and are to be responsive to sensor observations provided as input signals. In an implementation, a state and/or output signal of such a filter may indicate and/or infer detection of a presence or absence of a feature in an input signal.

In particular implementations, intelligent computing devices to perform functions supported by neural networks may comprise a wide variety of stationary and/or mobile devices, such as, for example, automobile sensors, biochip transponders, heart monitoring implants, kitchen appliances, locks or like fastening devices, solar panel arrays, home gateways, smart gauges, robots, financial trading platforms, smart telephones, cellular telephones, security cameras, wearable devices, thermostats, Global Positioning System (GPS) transceivers, personal digital assistants (PDAs), virtual assistants, laptop computers, personal entertainment systems, tablet personal computers (PCs), PCs, personal audio or video devices, personal navigation devices, just to provide a few examples.

According to an embodiment, a neural network may be structured in layers such that a node in a particular neural network layer may receive output signals from one or more nodes in an upstream layer in the neural network, and provide an output signal to one or more nodes in a downstream layer in the neural network. One specific class of layered neural networks may comprise a convolutional neural network (CNN) or space invariant artificial neural networks (SIANN) that enable deep learning. Such CNNs and/or SIANNs may be based, at least in part, on a shared-weight architecture of a convolution kernels that shift over input features and provide translation equivariant responses. Such CNNs and/or SIANNs may be applied to image and/or video recognition, recommender systems, image classification, image segmentation, medical image analysis, natural language processing, brain-computer interfaces, financial time series, just to provide a few examples.

Another specific class of layered neural networks may comprise a “spiking” neural network (SNN). In an embodiment, SNNs may be sought to more closely mimic biological neural networks. In addition to a neuronal and/or synaptic state, for example, an SNN may incorporate a concept of time into an operating model. In an implementation, neurons in an SNN may not transmit information at each propagation cycle (as may be the case with other perceptron networks), but rather transmit information only if a membrane potential—an intrinsic quality of a biological neuron related to its membrane electrical charge—reaches a specific value, called defining a threshold value. Responsive to such a membrane potential reaching a threshold value, a neuron may “fire” to generate a signal that travels to other receiving nodes/neurons which, in turn, increase or decrease respective potentials of receiving nodes/neurons in response to this signal.

In an implementation, behavior of a neuron in an SNN may be modeled according to a leaky integrate-and-fire model. In such an integrate-and-fire model, a momentary activation level (modeled as u(t) in a differential equation according to expression (1) below) may be considered to represent a neuron's state. Incoming spikes may push this activation level higher or lower, until the neuron's state eventually either decays or—if a firing threshold is reached—the neuron fires. After firing the state variable may be reset to a lower value.

$${τ}_{m} \frac{du}{dt} = - [ u ( t ) - {u}_{rest} ] + RI ( t ) , \qquad ( 1 )$$

where:

τₘ is a time constant;

uᵣₑₛₜ is a reset state; and

RI(t) is an impulse or “spike” term.

In an embodiment of the model according to expression (1), a condition u(t)>u_{T} may initiate a “firing” of an associated neuron. After such a firing event, u(t) may be reset to a lower value uᵣₑₛₜ. Multiple such firing events at a neuron may convey information (e.g., real-numbers, symbols, etc.). According to particular embodiments, various decoding methods may be used for interpreting a received spike train as a real-value number and/or symbol, relying, for example, on a frequency of spikes (rate-code), a time-to-first-spike after stimulation or an interval between spikes, or a combination thereof.

Energy consumed in processes to train neural networks has been growing at an unsustainable pace. Training neural networks of increasing size and complexity has further challenged efforts to implement machine-learning systems despite scaling advantages conferred by advanced process technology. Increased power and cooling requirements of newer systems to train machine learning models may restrict such endeavors to only the most highly funded projects. Additionally, a carbon footprint of training machine-learning model (e.g., a large natural language processing model) may be up to 300000 kg or more of carbon dioxide emissions.

SNNs may address some of scalability challenges in training machine-learning systems, and SNNs are sometimes viewed as a promising alternative to other types of neural networks. For example, closely mimicking biological neurons, an SNN may achieve considerable energy-efficiency advantages over conventional designs. Potential benefits of neuromorphic computing may be enabled by an event-driven nature of a computational paradigm and a sparsity in network architecture. In an event-driven network, for example, computation may be limited to conditions in which computation is necessary, which may lead to efficiency benefits which further enable further scalability of networks.

One interesting possibility is to use evolutionary techniques for training spiking neural networks. In an embodiment of a training regime employing SNNs, a population of networks may be created and techniques such as mutation, cross-over, and inheritance may be used to create another generation of networks. Networks may be applied to a problem of interest and relative fitness parameters may be evaluated at different process stages. Fitness may be determined by measuring a “distance” between a desired output of a trained network and an observed output signal in a higher dimensional space. Overfitting may be inherently reduced and/or avoided at least in part due to random processes, which may drive generation and selection of “fit” individuals within a population of networks.

It may be observed that observed stability of an algorithm may be questionable if a network structure varies greatly between iterations and/or generations. As such, to encourage forward-progress, one may employ augmentations such as locking down the neuron order within layers of the neural network, and ensuring that a fittest child is consistently fitter than an average parental fitness. One useful heuristic is comprise a number of parents which can be used to create a new generation of children. This parameter may be configurable and may depend on a problem domain and/or an amount of diversity expected.

According to an embodiment, an SNN may be trained at least in part by an initial assignment of random network parameter values (e.g., weights and/or biases), followed by training iterations based on training sets, for example. In such training iterations, network parameters may be randomly mutated to achieve diversity with a population of networks. Such a random mutation of network parameters may be achieved, at least in part, based on outputs from one or more random number generator circuits such as, for example, linear feedback shift registers (LFSRs). Use of such random number generator circuits may, however, may consume significant amounts of power and occupy a substantial portion of circuitry of a computing device, thereby undercutting power savings and computing density.

Briefly, particular embodiments described herein are directed to a method comprising: determining one or more parameters of a neural network node; altering at least one of the one or more parameters based, at least in part, on one or more error signals generated based, at least in part, on one or more errors generated by a local operational circuit; and determining a fitness of the altered at least one of the one or more parameters for solving a machine-learning problem. By altering parameters of a neural network parameters in iterations of a training operation based on one or more errors generated by a local operational circuit, costly random number generator circuits may be avoided.

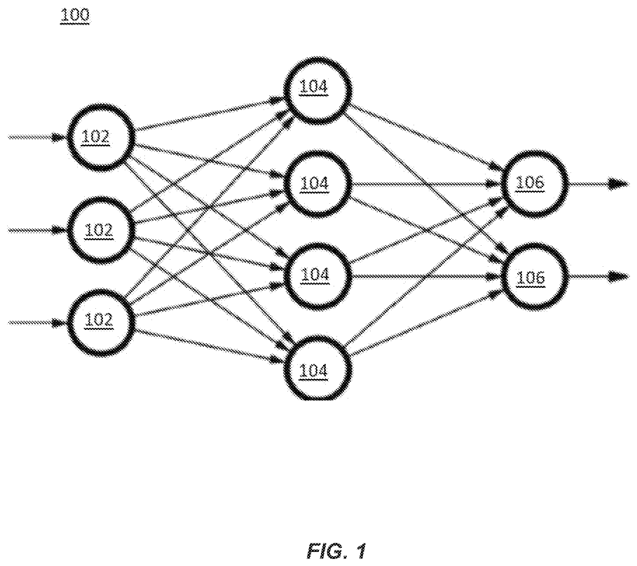

According to an embodiment, parameters of an SNN 100 shown in FIG. 1 may be trained on iterative operations over sequence of time intervals and/or epochs. During such a time interval and/or epoch, zero, one or more nodes/neurons 102 may “fire” to transmit a spike to nodes/neurons 104 and, likewise, zero, one or more nodes/neurons 104 may “fire” to transmit a spike to nodes/neurons 106. According to an embodiment, states of individual nodes/neurons 102, 104 and 106 may be represented as a stored voltage V that, if it exceeds a threshold voltage V_{T}, may initiate transmission of a spike to nodes in a subsequent layer of SNN 100. Based, at least in part on the leaky integrate-and-fire model described above in expression (1), a voltage decay according to a time constant T (e.g., determined, at least in part, based on conductance and capacitance effects) may be expressed according to expression (2) as follows:

$${V}_{t 2} = {V}_{t 1} \times {e}^{\frac{- ( t 2 - t 1 )}{τ}} + {V}_{rest} , \qquad ( 2 )$$

where:

Vₜ₂ is a stored voltage at time t2;

Vₜ₁ is a stored voltage at time t1; and

Vᵣₑₛₜ is a resting potential.

According to an embodiment, a spike transmitted to a node/neuron may deliver a quantum of charge to affect a stored voltage at the node/neuron. Such delivered charge may be collectively integrated over time to produce potential differences V_{q} according to expression (3) as follows:

$${V}_{t 2} = {V}_{t 1} \times {e}^{\frac{- ( t 2 - t 1 )}{τ}} + {V}_{rest} + {\sum }_{i = 0}^{N - 1} {S}_{i} \times {V}_{q} , \qquad ( 3 )$$

where Sᵢ reflects a degree of connectivity between nodes/neurons, various conductances and synaptic delays. Assuming a degree of periodicity, application of a Fourier transform to expression (3) as shown in expression (4) as follows may enable frequency domain analysis:

Vₘ=Σᵢ₌₀^{N-1}P_{i,m}×Kᵢrₘ, (4)

where:

Vₘ is a potential voltage during an epoch/interval in which neuron/node m has not yet fired;

P_{i,m} is a probability that neuron/node m will fire in epoch/interval i if neuron/node m;

Kᵢ is a spike term having a value of zero or one in epoch/interval i; and

rₘ is a resting potential of neuron/node m.

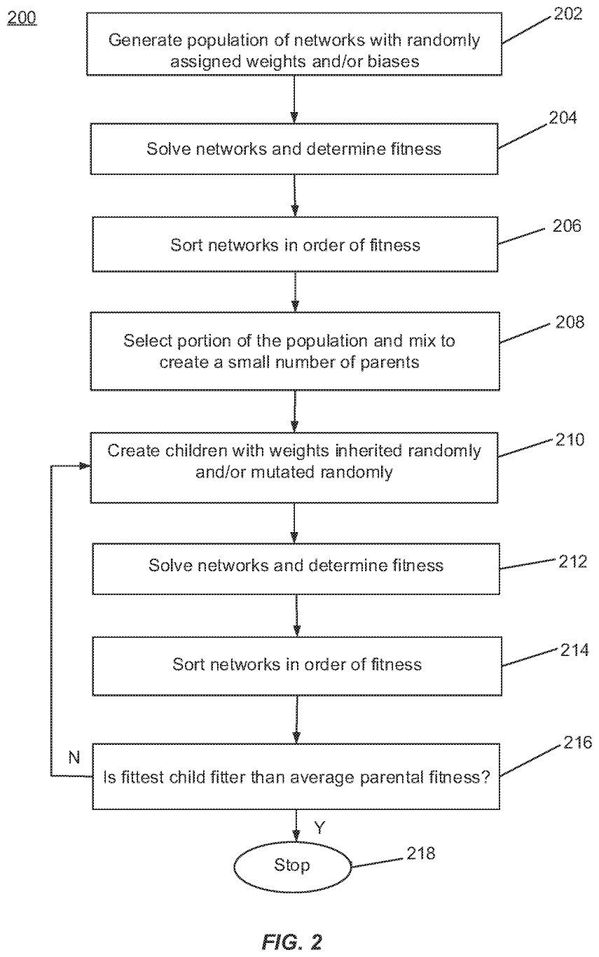

FIG. 2 is a flow diagram of a process 200 to train an SNN that does not rely on differentiability of spikes generated by neurons/nodes or back-propagation (e.g., stochastic gradient descent). In an implementation, process 200 may employ an evolutionary technique involving generating a population of trained SNNs. Block 202 may comprise generation of a population of networks with randomly assigned parameters (e.g., weights to be associated with individual nodes). Process 200 may iteratively create child networks based on randomly mutated parameters at blocks 210 through 216. In an embodiment, a set single structure and/or topology may define nodes/neurons, layers and edges between connecting nodes/neurons may be established for SNNs in a population of SNNs created at block 202. Thus, different networks in a population of networks created at block 202 may vary based on weights assigned to edges connecting neurons/nodes and/or biases. According to an embodiment, a weight assigned to an edge in an SNN (e.g., at blocks 202 and 210) may represent synaptic delay and/or impart another signal-modulate effect associated with connectivity at a neuronal junction. In a particular implementation, a magnitude of a spike (e.g., a magnitude of such a spike exceeding a threshold value) itself may be of limited relevance. However, relative timing and/or arrival rate of such a spike may vary (e.g., to encode information) according to assigned weights. In a particular implementation, such weights may be expressed as probabilities (e.g., probabilities P_{i,m} for the purpose of an evolutionary algorithm as described herein). Resting potential rₘ may be encoded as biases to enable progression through a search space more efficiently during training, for example, by mutating such biases at rates different from which values for P_{i,m} are to be mutated.

According to an embodiment, block 204 may execute iterations of networks created at block 202 to process training sets. In these iterations, parameters of individual networks (e.g., weights) may be adjusted so as to minimize a loss function to be applied to desired “solutions” of the individual networks. In lieu of back-propagation, a population of SNNs may be generated and solved for fitness, and progress may proceed according to one or more loss functions. In an embodiment, a fitness of a network “solved” at block 204 may be determined according to a magnitude of a loss function that is computed based, at least in part, on at least a portion of a training set. Block 206 may sort and/or rank networks solved at block 204 based, for example, on associated computed magnitudes of the loss function.

Block 208 may comprise selection of a subset of networks solved at block 204. For example, such a subset of networks may be selected based, at least in part, on a sorting and/or ranking determined at block 206. Of networks selected at block 208, block 210 may create associated “child” networks based, at least in part, on a random mutation of associated parameters that differentiate networks among the selected subset of networks. In an embodiment, block 212 may solve child networks created at block 210 according to a loss function (e.g., same or different loss function applied at block 204) based, at least in part, on iterations of solved child networks applied to a training set (e.g., same or different training set applied at block 204).

According to an embodiment, blocks 204 and 212 may be directed to determining network parameters for a solution to one or more machine-learning problems. In this context, “solving” a machine-learning problem as referred to herein means application of a process to improve an ability of a computer algorithm, by experience and use of observational training parameter sets to, for example, make predictions and/or decisions. Such a process to improve an ability of a computer algorithm may occur without explicit programming of the computer algorithm. Such an ability to make predictions and/or decisions may be applied to disciplines such as medicine, email filtering, speech recognition, computer vision or other disciplines conventional algorithms may be infeasible in performing desired or needed tasks.

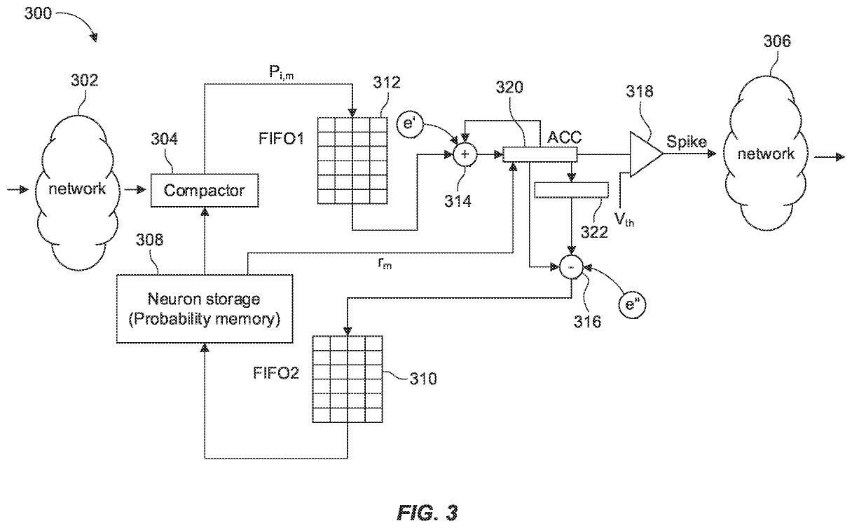

According to an embodiment, a weighted average of probabilities P_{i,m} associated with a particular node/neuron m may be sampled from among the “fittest” networks as determined at block 214. Such probabilities from different networks associated with the particular node/neuron m may be weighted based, at least in part, on respective levels of fitness of the different networks. In some embodiments, a relationship between a weighting factor of a network and an associated level of fitness may be expressed as an exponential function such that relatively unfit parent networks impart a relatively minor effect to a subsequent generation of networks. Such a weighted average computation may also make use of “drowsy” circuitry as described with reference to FIG. 3 (e.g., with some modification to apply computations across a population of multiple networks rather than within a single network). Using “drowsy” circuitry for computing weighted averages of P_{i,m} may also impart an additional element of randomness in a “cross-over stage.” In such a cross-over state, according to an embodiment, contributions to individual child SNNs from multiple parents may be mixed and/or conflated. In one example, if a first particular parent SNN is to be defined in part by a set of weights {A1, B1, C1} and a second particular parent SNN is to be defined in part by weights {A2, B2, C2}, a cross-over may spawn a child SNN defined in part by weights {A1, B2, C1}. In another example, such a cross-over of first and second particular parent SNNs may spawn a child defined in part by weights {(w1*A1+w2*A2), (w1*B1+w2*B2), (w1*C1+w2*C2)}, wherein w1 and w2 are coefficients generated by a weighted averaging process dependent on a fitness metric, for example. In a particular implementation, weights of parent SNNs with a high fitness metric may be assigned a relatively high weighting factor and, as a result, may impart a higher contribution to weights defining a child. In an example, a relationship between and/or among weighting factors and/or coefficients and fitness metric may be non-linear.

Block 214 may sort and/or rank, for example, based on magnitudes of associated computations of a loss function. Of child networks sorted/ranked at block 214, block 216 may determine whether a fittest child network (e.g., based, at least, in part, on magnitudes of computations of a loss function for child networks created at block 210) is fitter than a threshold level of fitness. If a fitness of such the fittest child network exceeds such a threshold level of fitness, the fittest child network may be selected as a trained network, and process 200 may terminate at block 218. If such a fitness of the fittest child does not exceed the threshold level of fitness, block 210 may create child networks based, at least in part, on network solutions determined in a previous iteration of block 212.

According to an embodiment, a threshold level of fitness applied at block 216 may be determined based, at least in part, on a computed fitness of parent networks. For example, such a threshold level may be determined as an average value of magnitudes of fitness values computed for parent networks. In another example, such a threshold level may be determined as a median magnitude of fitness values computed for parent networks. It should be understood, however that these are merely examples of how a threshold level of fitness may be determined for application at block 216, and claimed subject matter is not limited in this respect.

In particular implementations, a random mutation of features of a network (e.g., weights) (e.g., at block 210) may be achieved using output signals from one or more random number generator circuits such as, for example, the aforementioned LFSRs. As pointed out above, use of such a random number generator circuits may consume significant amounts of power and occupy a substantial portion of circuitry of an integrated computing device, thereby undercutting power savings and computing density. According to an embodiment, in lieu of artificial stochasticity injection at blocks 202 and/or 210 using specialized random number generation circuitry, error signals provided by operational circuitry may introduce a degree of randomness sufficient for mutating network features. Such operational circuitry may comprise any type of simple operational circuit that is implemented for a purpose other than generation of a random signal. In a particular implementation, such circuits may be implemented with low supply voltages and/or current-starved circuitry (e.g., current-starved adders and/or subtractors) which may from time to time fail to produce accurate output signals while operating at a given clock frequency. Such circuits may therefore provide some diversity in neural network parameters mutated at blocks 202 and 210, while operating at low power levels and minimally impacting computing density of an integrated circuit device. In a modification of a model of a stored voltage at a neuron/node according to expression (4), in a particular implementation, such circuits may generate error terms e′ and e″ in expression (5) as follows:

Vₘ=Σᵢ₌₀^{N-1}(P_{i,m}+e′)×Kᵢ+rₘ+e″ (5)

FIG. 3 is a schematic diagram of a circuit 300 to alter at least one of one or more parameters of a neural network node/neuron based, at least in part, on one or more error signals generated by a local operational circuit, according to an embodiment. In a particular implementation, such one or more error signals generated by a local operational circuit may, at least in part, implement a random assignment and/or modification of weights and/or biases to nodes/neurons in a network at block 202 and/or randomly mutate weights and/or parameters nodes/neurons in a network at block 210. For example, circuit 300 may be used to implement at least a portion of computation of Vₘ shown in expression (5).

According to an embodiment, circuitry 300 may implement functionality of one or more nodes/neurons. In an implementation, instances of circuit 300 may be distributed throughout an integrated circuit device in a “spatial” fashion. For example, such an integrated circuit may comprise circuitry/features to “route” spikes transmitted from source nodes/neurons to destination nodes/neurons. Such circuitry/features may at least in part implement network 302 to route spikes to a compactor unit 304. In an embodiment, compactor circuit 304 may read and/or retrieve associated probability values from locations in a storage memory 308 allocated to nodes/neurons. For example, particular locations m in storage memory 308 may be allocated to store probability values associated with a particular associated node/neuron m. In some implementations, storage memory 308 may store probability values P_{i,m} in multiple different locations for different epochs/intervals for a node/neuron m. Alternatively, multiple locations may be allocated to store probability values for neurons at the same spatial position within different networks (in a population of networks) used during training operations, for example. Compactor circuit 304 may load retrieved and/or read associated probability values P_{i,m} to locations in a first-in-first-out (FIFO) queue 312. In one implementation, positions in FIFO queue 312 may contain scalar values for different probability values P_{i,m} for a single particular node/neuron m. In an alternative implementation, positions in FIFO queue 312 may contain vectors of a dimension n to express different probability values P_{i,m} associated with multiple different nodes/neurons m∈1, 2, . . . , n. Such a vectorization of FIFO queue 312 may enable amortization of circuitry costs across multiple nodes/neurons and/or accelerate computation within a single instance of circuit 300.

According to an embodiment, on any one particular epoch and/or interval, only a relatively small number of nodes/neurons in a given layer may fire, contributing to temporal sparsity in communications between nodes/neurons pointed out above. According to an embodiment, compactor circuit 304 may tailor operations to reduce unnecessary computations applicable to multiple nodes/neurons m. For example, in a particular epoch and/or interval, no spike message may be transmitted to particular nodes/neurons to be routed to compactor circuit 304, and therefore no associated probability value may be retrieved from storage memory 308, and additional operations at circuit 300 may be avoided. pertaining to every neuron in that case.

According to an embodiment, probability values P_{i,m} loaded to FIFO queue 312 may, at addition circuit 314, be added to a state of accumulator 320 (e.g., tracking an internal charge state of an associated spiking node/neuron). Additionally, values for Kᵢ may encode a presence or absence of a spike in an epoch/interval i. According to an embodiment, compactor 304 may implement values for Kᵢ in that compactor may limit access to values in neuron storage 308 to particular intervals i in which a spike is to be received from network 302. As pointed out above, a value injected for e′ may be obtained from low voltage and/or current-starved operation of a particular local operational circuit (not shown). In some particular implementations, such a local operational circuit may be selected and/or tailored to affect a distribution of an error about a mathematically desired result by, for example, adjusting parameters such as a supply voltage, current drivers, load capacitances, operating clock frequencies, circuit design parameters and/or operating temperature, just to provide a few examples of how an operational circuit may be adjusted to affect properties of a generated error term e′.

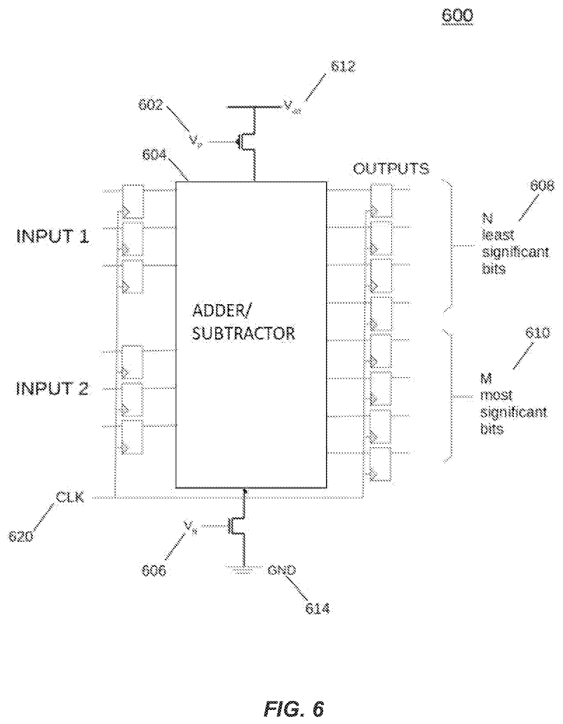

According to an embodiment, addition circuit 314 and/or subtraction circuit 316 may be configured to generate and inject error signals (e.g., error signals e′ and/or e″) into operations illustrated in FIG. 3. In a particular implementation, features of circuit 600 shown in FIG. 6 may be included in addition circuit 314 and/or subtraction circuit 316 to enable addition circuit 314 and/or subtraction circuit 316 to generate error signals e′ and/or e″, respectively. In particular implementations, error signals e′ and/or e″ according to FIGS. 3 and/or FIG. 6 are to be generated by operational circuits for addition and/or subtraction of signals without the use of specialized random number/signal generation circuitry. In a particular example, addition circuit 314 may be implemented in part by adder/subtractor circuit 604 which, by way of example, may comprise a carry-lookahead adder circuit. Here, adder/subtractor circuit 604 may be connected via additional current flow control circuitry (not shown) to supply voltage V_{dd} 612 and ground reference GND 614. Current-starvation behavior and/or a signal resulting from modulation by a signal propagation delay may arise from maintaining gate voltages V_{P} 602 and V_{N} 606 at levels to induce current flow restrictions to adder/subtractor circuit 604. Error signals e′ and/or e″ may be generated by maintaining a period of clock signal CLK 620 static while changes in gate voltages V_{P} 602 and V_{N} 606 occur. Error signals e′ and/or e″ may manifest as signals that are registered by flip-flops connected to output terminals of adder/subtractor circuit 604. Increases in propagation delays experienced by adder/subtractor circuit 604 may manifest as error signals. In some embodiments, such increases in propagation delay may result from simultaneously reducing a magnitude of gate voltage V_{N} 606 and increasing the magnitude of gate voltage V_{P} 602. An alternative embodiment may employ current mirrors (not shown) to control flow of current through the adder/subtractor circuit 604 and/or generate gate voltages V_{P} 602 and V_{N} 606, for example.

In an implementation, data bits provided at output terminals of adder/subractor circuit 604 may be separated further into a set of N least significant bits 608 and a set of M most significant bits 610 such that a rate of errors generated in least significant bits 608 may be controlled to be higher than a rate of errors generated in most significant bits 610. This may be achieved, for example, in a carry-lookahead adder (not shown) by leveraging a modular organization and employing multiple current flow control circuits (not shown). Such multiple flow control circuits may ensure that signal propagation delays are to be higher in computed of least significant bits 608 relative to signal propagation delays in computation of most significant bits 610. In this manner, a plurality of current flow control circuits may be used to tailor a distribution of errors between and/or among multiple circuits (e.g., multiple circuits to implement addition circuit 314 and subtraction circuit 316). Dynamically tailoring such a process affect a distribution between and/or among circuits may enable certain advantages. For example, dynamically tailoring such a distribution of errors may enable control of a level of entropy to be imparted during training operations. This may affect a learning rate to be balanced with a goal of avoiding a local minima during training. In one implementation, for example, an error distribution may be wider in early phases of training while progressively narrowing in later phases.

In one implementation, one or more of these parameters to affect an error distribution may be determined/configured during in a hardware design stage. Others of these parameters may be adjusted dynamically during training operations to impart various levels of “drowsiness” as training operations progress. For example, a network may be extremely somnolent at the start of training with very wide distributions of errors e′ and e″, and then become less drowsy after multiple training epochs (e.g., for narrower error distributions). To stabilize such a training process and avoid excessive perturbations and/or undesirable drift, a subtraction circuit 316 may be provided in a return pathway to carry mutated probability values to a memory location in storage memory 308 associated with the neuron's internal storage via FIFO queue 310. In this manner, mutation may be fully enabled while probability values may be transformed in a controllable fashion. It may also be observed that, similar to addition circuit 314, subtraction circuit 316 may inject an additional error signal e″. Taken together, error signals e′ and e″ may introduce significant diversity in a population of SNNs.

If a state of accumulator 320 were to rise above a configured threshold voltage Vₜₕ, an associated node/neuron may fire and transmit a spike message via an interconnect to nodes/neurons in a downstream layer connected by an edge. Accumulator circuit 320 may then be reset (e.g., set to a resting potential) and any subsequent spikes impinging on that neuron within that epoch may be ignored (akin to the refractory interval observed in biological neurons). If a particular node/neuron does not fire in a particular epoch and/or interval, and there are no additional incoming spikes are to be received by the particular node/neuron in the particular epoch, circuit 300 may reset an accumulator state of a corresponding accumulator register of accumulator circuit 320. Processing of incoming spikes to be received by a different node/neuron may then commence.

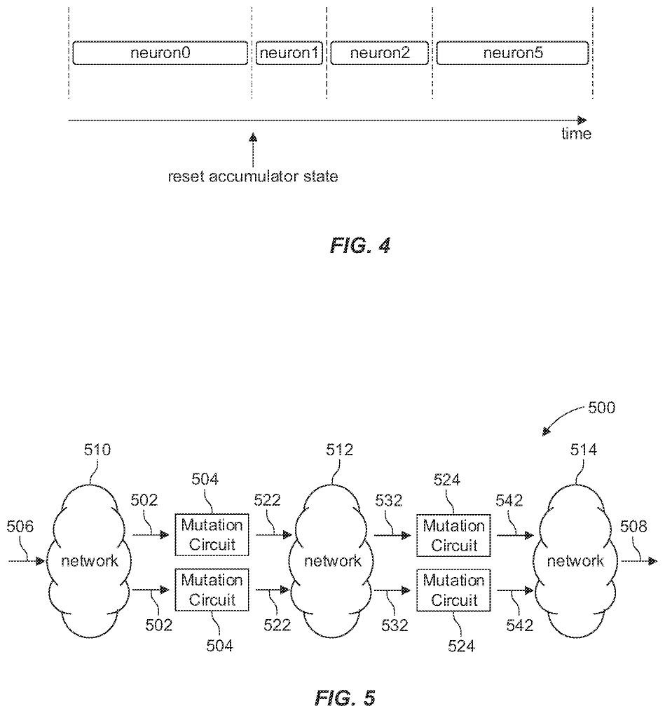

According to an embodiment as illustrated in FIG. 4, for example, circuit 300 to affect a mutation of parameters of an SNN node/neuron may be applied to multiple different nodes/neurons in a time-division-multiplex fashion. As may be observed, upon reset of accumulator circuit 320 (e.g., following an end of an epoch and/or firing of a spike by neuron0), circuit 300 may commence processing spikes received by neuron1. Likewise, upon reset of accumulator circuit 320 following an end of an epoch and/or firing of a spike by neuron1, circuit 300 may commence processing spikes received by neuron2, and so forth. According to an embodiment, a current epoch i may be further partitioned into periods T and spikes received by a given neuron in a preceding period T (e.g., the start of the current epoch i) may be processed in the current epoch i. Such processing may be performed until the end of the current epoch i or until the given neuron fires. Processing may then be repeated for other neurons in other epochs until such other neurons “fire” responsive to spikes received in the preceding period T have been processed. To ensure that the processing remains tractable with respect to the passage of time, for example, the period of time defined by the period T as seen by all neurons within a given layer may be assumed to be co-terminus.

In an alternative embodiment, an architecture may implement mutation circuits in a pipeline fashion such that multiple circuits 300 may process spikes received at multiple different associated nodes/neurons in an SNN. As shown in the particular implementation of a circuit 500 in FIG. 5, mutation circuits 504 and 524 may be implemented, at least in part, according to features of circuit 300 (FIG. 3). In an embodiment, spikes 502 may be generated, at least in part, based on an activation input signal 506. In this context, an “activation input value” as referred to herein means a value to an activation function defined and/or represented by one or more nodes/neurons in a neural network. Mutation circuits 504 disposed between networks 510 and 512 may process spikes 502 received at corresponding nodes/neurons in a first layer of a SNN. Mutation circuits 524 disposed between networks 512 and 514 may process spikes 532 received at corresponding nodes/neurons in a second, downstream, layer of the SNN. In an embodiment, network 512 may route spikes generated by mutation circuits 504 (according to nodes/neurons in the first layer) as spikes 532 to be received by at least some nodes/neurons in the second layer. Network 514 may route spikes 542 generated by mutation circuits 524 to at least in part provide activation output signal 508. In this context, an “activation output value” as referred to herein means an output value provided by an activation function defined and/or represented by one or more nodes of a neural network.

In the context of the present patent application, the term “connection,” the term “component” and/or similar terms are intended to be physical but are not necessarily always tangible. Whether or not these terms refer to tangible subject matter, thus, may vary in a particular context of usage. As an example, a tangible connection and/or tangible connection path may be made, such as by a tangible, electrical connection, such as an electrically conductive path comprising metal or other conductor, that is able to conduct electrical current between two tangible components. Likewise, a tangible connection path may be at least partially affected and/or controlled, such that, as is typical, a tangible connection path may be open or closed, at times resulting from influence of one or more externally derived signals, such as external currents and/or voltages, such as for an electrical switch. Non-limiting illustrations of an electrical switch include a transistor, a diode, etc. However, a “connection” and/or “component,” in a particular context of usage, likewise, although physical, can also be non-tangible, such as a connection between a client and a server over a network, particularly a wireless network, which generally refers to the ability for the client and server to transmit, receive, and/or exchange communications, as discussed in more detail later.

In a particular context of usage, such as a particular context in which tangible components are being discussed, therefore, the terms “coupled” and “connected” are used in a manner so that the terms are not synonymous. Similar terms may also be used in a manner in which a similar intention is exhibited. Thus, “connected” is used to indicate that two or more tangible components and/or the like, for example, are tangibly in direct physical contact. Thus, using the previous example, two tangible components that are electrically connected are physically connected via a tangible electrical connection, as previously discussed. However, “coupled,” is used to mean that potentially two or more tangible components are tangibly in direct physical contact. Nonetheless, “coupled” is also used to mean that two or more tangible components and/or the like are not necessarily tangibly in direct physical contact, but are able to co-operate, liaise, and/or interact, such as, for example, by being “optically coupled.” Likewise, the term “coupled” is also understood to mean indirectly connected. It is further noted, in the context of the present patent application, since memory, such as a memory component and/or memory states, is intended to be non-transitory, the term physical, at least if used in relation to memory necessarily implies that such memory components and/or memory states, continuing with the example, are tangible.

Unless otherwise indicated, in the context of the present patent application, the term “or” if used to associate a list, such as A, B, or C, is intended to mean A, B, and C, here used in the inclusive sense, as well as A, B, or C, here used in the exclusive sense. With this understanding, “and” is used in the inclusive sense and intended to mean A, B, and C; whereas “and/or” can be used in an abundance of caution to make clear that all of the foregoing meanings are intended, although such usage is not required. In addition, the term “one or more” and/or similar terms is used to describe any feature, structure, characteristic, and/or the like in the singular, “and/or” is also used to describe a plurality and/or some other combination of features, structures, characteristics, and/or the like. Likewise, the term “based on” and/or similar terms are understood as not necessarily intending to convey an exhaustive list of factors, but to allow for existence of additional factors not necessarily expressly described.

In a particular implementation, circuit 300, 500 and/or 600 may comprise transistors and/or lower metal interconnects (not shown) formed in processes (e.g., front end-of-line and/or back-end-of-line processes) such as processes to form complementary metal oxide semiconductor (CMOS) circuitry, just as an example. It should be understood, however that this is merely an example of how circuitry may be formed in a substrate in a front end-of-line process, and claimed subject matter is not limited in this respect.

It should be noted that the various circuits disclosed herein may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. Storage media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, etc.).

If received within a computer system via one or more machine-readable media, such data and/or instruction-based expressions of the above described circuits may be processed by a processing entity (e.g., one or more processors) within the computer system in conjunction with execution of one or more other computer programs including, without limitation, net-list generation programs, place and route programs and the like, to generate a representation or image of a physical manifestation of such circuits. Such representation or image may thereafter be used in device fabrication, for example, by enabling generation of one or more masks that are used to form various components of the circuits in a device fabrication process.

In the context of the present patent application, the term “between” and/or similar terms are understood to include “among” if appropriate for the particular usage and vice-versa. Likewise, in the context of the present patent application, the terms “compatible with,” “comply with” and/or similar terms are understood to respectively include substantial compatibility and/or substantial compliance.

For one or more embodiments, features of circuits 300 and/or 500 may be implemented in a device, such as a computing device and/or networking device, that may comprise, for example, any of a wide range of digital electronic devices, including, but not limited to, desktop and/or notebook computers, high-definition televisions, digital versatile disc (DVD) and/or other optical disc players and/or recorders, game consoles, satellite television receivers, cellular telephones, tablet devices, wearable devices, personal digital assistants, mobile audio and/or video playback and/or recording devices, Internet of Things (IOT) type devices, or any combination of the foregoing. Further, unless specifically stated otherwise, a process as described, such as with reference to flow diagrams and/or otherwise, may also be executed and/or affected, in whole or in part, by a computing device and/or a network device. A device, such as a computing device and/or network device, may vary in terms of capabilities and/or features. Claimed subject matter is intended to cover a wide range of potential variations. For example, a device may include a numeric keypad and/or other display of limited functionality, such as a monochrome liquid crystal display (LCD) for displaying text, for example. In contrast, however, as another example, a web-enabled device may include a physical and/or a virtual keyboard, mass storage, one or more accelerometers, one or more gyroscopes, global positioning system (GPS) and/or other location-identifying type capability, and/or a display with a higher degree of functionality, such as a touch-sensitive color 2D or 3D display, for example.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

Also, in the context of the present patent application, the term “parameters” (e.g., one or more parameters), “values” (e.g., one or more values), “symbols” (e.g., one or more symbols) “bits” (e.g., one or more bits), “elements” (e.g., one or more elements), “characters” (e.g., one or more characters), “numbers” (e.g., one or more numbers), “numerals” (e.g., one or more numerals) or “measurements” (e.g., one or more measurements) refer to material descriptive of a collection of signals, such as in one or more electronic documents and/or electronic files, and exist in the form of physical signals and/or physical states, such as memory states. For example, one or more parameters, values, symbols, bits, elements, characters, numbers, numerals or measurements, such as referring to one or more aspects of an electronic document and/or an electronic file comprising an image, may include, as examples, time of day at which an image was captured, latitude and longitude of an image capture device, such as a camera, for example, etc. In another example, one or more parameters, values, symbols, bits, elements, characters, numbers, numerals or measurements, relevant to digital content, such as digital content comprising a technical article, as an example, may include one or more authors, for example. Claimed subject matter is intended to embrace meaningful, descriptive parameters, values, symbols, bits, elements, characters, numbers, numerals or measurements in any format, so long as the one or more parameters, values, symbols, bits, elements, characters, numbers, numerals or measurements comprise physical signals and/or states, which may include, as parameter, value, symbol bits, elements, characters, numbers, numerals or measurements examples, collection name (e.g., electronic file and/or electronic document identifier name), technique of creation, purpose of creation, time and date of creation, logical path if stored, coding formats (e.g., type of computer instructions, such as a markup language) and/or standards and/or specifications used so as to be protocol compliant (e.g., meaning substantially compliant and/or substantially compatible) for one or more uses, and so forth.

It has proven convenient at times, principally for reasons of common usage, to refer to such physical signals and/or physical states as bits, values, elements, parameters, symbols, characters, terms, samples, observations, weights, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically in the form of physical electronic and/or magnetic quantities, within memories, registers, and/or other storage devices, processing devices, and/or display devices of the special purpose computer and/or similar special purpose computing and/or network device. In the context of this particular patent application, as mentioned, the term “specific apparatus” therefore includes a general purpose computing and/or network device, such as a general purpose computer, once it is programmed to perform particular functions, such as pursuant to program software instructions.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A method comprising:
determining one or more parameters of a neural network node;
altering at least one of the one or more parameters based, at least in part, on one or more error signals generated based, at least in part, on one or more errors generated by a local operational circuit; and
determining a fitness of the altered at least one of the one or more parameters for solving a machine-learning problem.

2. The method of claim 1, wherein the local operational circuit comprises a reduced-voltage and/or reduced-current circuit.

3. The method of claim 1, and further comprising varying the one or more error signals responsive, at least in part, to adjustments in a supply voltage, current driver, load capacitance, operating clock frequency or operating temperature, or a combination thereof.

4. The method of claim 1, wherein the neural network node comprises a spiking neural network.

5. The method of claim 1, and further comprising varying a current and/or voltage applied to the local operational circuit to vary a distribution of the one or more error signals.

6. The method of claim 1, wherein the fitness is determined based, at least in part, on a computation of a loss function.

7. The method of claim 6, and further comprising:
ranking the neural network relative to other neural networks based, at least in part, on the determined fitness; and
selectively spawning a child of the neural network based, at least in part, on the ranking.

8. A circuit to alter one or more parameters of a neural network, comprising:
a first circuit to determine at least one of the one or more first parameters of a first neural network node;
a first local operational circuit; and
a first circuit to alter the at least one of the one or more first parameters based, at least in part, on one or more error signals generated based, at least in part, on one or more errors generated by the first local operational circuit.

9. The circuit of claim 8, and further comprising:
a circuit to determine at least one of the one or more second parameters of a second neural network node;
a second local operational circuit; and
a circuit to alter the at least one of the one or more second parameters based, at least in part, on one or more error signals generated based, at least in part, on one or more errors generated by the second local operational circuit, wherein the first and second neural network nodes are disposed in a same layer of the neural network.

10. The circuit of claim 8, and further comprising:
a circuit to determine at least one of one or more second parameters of a second neural network node;
a second local operational circuit; and
a circuit to alter the at least one of the one or more second parameters based, at least in part, on one or more error signals generated by the second local operational circuit, wherein the one and further comprising, wherein:
the first neural node is disposed in a first layer of the neural network and the second neural network is disposed in a second layer of the neural network that is downstream of the first layer of the neural network.

11. The circuit of claim 10, and further comprising a network to route a spike signal generated based, at least in part, on the altered at least one of the one or more first parameters to the circuit to alter the at least one of the one or more second parameters.

12. The circuit of claim 8, wherein the first local operational circuit comprises a reduced-voltage and/or reduced-current circuit.

13. The circuit of claim 8, wherein the and further comprising varying the one or more error signals responsive, at least in part, to adjustments in a supply voltage, current driver, load capacitance, operating clock frequency or operating temperature, or a combination thereof.

14. The method of claim 8, wherein the neural network node comprises a spiking neural network.

15. The circuit of claim 8, and further comprising varying a current and/or voltage applied to the first local operational circuit to vary a distribution of the one or more error signals.

16. An article comprising:
a non-transitory storage medium comprising computer-readable instructions stored thereon that are executable by one or more processors of a computing device to:
express a circuit, to be formed in a circuit device, to determine one or more parameters of a neural network node; and
express a circuit, to be formed in the circuit device, to alter at least one of the one or more parameters based, at least in part, on one or more error signals generated based, at least in part, on one or more errors generated by a first local operational circuit.

17. The article of claim 16, wherein the computer-readable instructions stored thereon that are executable by one or more processors of a computing device to determine a fitness of the altered at least one of the one or more parameters for solving a machine-learning problem.

18. The article of claim 16, wherein the computer-readable instructions are formatted according to a register description language.

19. The article of claim 16, and wherein the computer-readable instructions are further executable by the one or more processors to:
express a circuit to be formed in the circuit device to determine at least one of the one or more second parameters of a second neural network node;
express a second local operational circuit to be formed in the circuit device; and
express a circuit to alter the at least one of the one or more second parameters based, at least in part, on one or more error signals generated based, at least in part, on one or more errors generated by the second local operational circuit, wherein the first and second neural network nodes are disposed in a same layer of the neural network.

20. The article of claim 16, wherein the neural network node comprises a spiking neural network.
